(19) United States
(12) Patent Application Publication
(10) Pub. No.: US 2026/0091672 A1
(43) Pub. Date: Apr. 2, 2026

(54) GAZE DETECTION APPARATUS, GAZE DETECTION METHOD, AND RECORDING MEDIUM

(71) Applicant: HONDA MOTOR CO., LTD., Tokyo (JP)

(72) Inventors: Takumi Torii, Wako-shi (JP); Masamitsu Shiono, Wako-shi (JP)

(21) Appl. No.: 19/333,943

(22) Filed: Sep. 19, 2025

(30) Foreign Application Priority Data
Sep. 30, 2024 (JP) 2024-171116

(51) Int. Cl. B60K 35/235; B60K 35/10; B60K 35/28

(52) U.S. Cl. CPC B60K 35/235; B60K 35/10; B60K 35/285; B60K 2360/178; B60K 2360/589

(57) ABSTRACT

A manipulation assistance unit that functions as a gaze detection apparatus includes: an interpupillary distance detector that detects an interpupillary distance of a driver, who is a target person; and a gaze detector that detects a gaze position of the driver, wherein the gaze detector includes a gaze change determiner that determines that, if the gaze change determiner detects an eye movement involving two occurrences of change in the interpupillary distance within a predefined time period, the change in the interpupillary distance being equal to or greater than a predefined amount, a change has occurred in the gaze position of the driver, the change in the gaze position involving a change in viewing distance.

### INCORPORATION BY REFERENCE

The present application claims priority under 35 U.S.C. § 119 to Japanese Patent Application No.2024-171116 filed on Sep. 30, 2024. The content of the application is incorporated herein by reference in its entirety.

### BACKGROUND OF THE INVENTION

### Field of the Invention

The present invention relates to a gaze detection apparatus, a gaze detection method, and a recording medium.

### Description of the Related Art

In recent years, research and development have been conducted to acquire data and the like regarding an interpupillary distance of a user for providing assistance.

For example, International Publication No. WO 2020152732 discloses a technology that determines a gaze direction and an eye movement state based on the positions of a first pupil coordinate, a second pupil coordinate, a first inner canthus coordinate, and a second inner canthus coordinate. It also describes that the eye movement states include movement states of the both eyes, such as gaze movements in up-down directions, gaze movements in left-right directions, convergence movement, or divergence movement, and a heterophoria state (i.e., ocular deviation) where a change in position of one pupil is equal to or greater than a threshold value and a change in position of the other pupil is less than the threshold value.

The conventional technology is to detect a gaze position simply based on the position of the left and right pupils, and it does not exploit gaze detection that takes account of a particular eye movement in a living body such as a human. Accordingly, depending upon the computational performance of a processor used for the detection of the gaze position, the conventional technology may not be able to identify a change in the gaze position rapidly. The present application addresses the challenge of enabling rapid identification of a change in the gaze position by utilizing a particular eye movement.

An object of the present application is to enhance safety through addressing the challenge described above. Consequently, the present application is to further improve traffic safety and contribute to the advance of sustainable transportation systems.

### SUMMARY OF THE INVENTION

In an aspect of the present disclosure, there is a gaze detection apparatus including: an interpupillary distance detector configured to detect an interpupillary distance between left and right eyes of a target person based on an image including the eyes of the target person; and a gaze detector configured to detect a gaze position of the target person based on obtained information including the interpupillary distance, wherein the gaze detector includes a gaze change determiner configured to determine that, if the gaze change determiner detects an eye movement based on the obtained information, the eye movement involving a plurality of occurrences of change in the interpupillary distance within a predefined time period, the change in the interpupillary distance being equal to or greater than a predefined amount, a change has occurred in the gaze position of the target person, the change in the gaze position involving a change in viewing distance.

In another aspect of the present disclosure, there is a gaze detection method executed by a gaze detection apparatus, the method including: an interpupillary distance detection step of detecting an interpupillary distance between left and right eyes of a target person based on an image including the eyes of the target person; and a gaze detection step of detecting a gaze position of the target person based on obtained information including the interpupillary distance, wherein the gaze detection step includes gaze change determination processing to determine that, if an eye movement is detected based on the obtained information, the eye movement involving a plurality of occurrences of change in the interpupillary distance within a predefined time period, the change in the interpupillary distance being equal to or greater than a predefined amount, a change has occurred in the gaze position of the target person, the change in the gaze position involving a change in viewing distance.

In another aspect of the present disclosure, there is a non-transitory computer readable recording medium recording a program that causes a computer-controlled gaze detection apparatus to function as: an interpupillary distance detector that detects an interpupillary distance between left and right eyes of a target person based on an image including the eyes of the target person; and a gaze detector that detects a gaze position of the target person based on obtained information including the interpupillary distance, wherein the gaze detector includes a gaze change determination processing to determine that, if an eye movement is detected based on the obtained information, the eye movement involving a plurality of occurrences of change in the interpupillary distance within a predefined time period, the change in the interpupillary distance being equal to or greater than a predefined amount, a change has occurred in the gaze position of the target person, the change in the gaze position involving a change in viewing distance.

In accordance with an aspect of the present invention, a change in gaze position can be rapidly identified by using a particular eye movement.

### BRIEF DESCRIPTION OF THE DRAWINGS

FIG. 1 shows a configuration of a manipulation assistance system according to a first embodiment;

FIG. 2 shows a configuration of a portion of a vehicle close to a driver seat;

FIG. 3 shows a relationship between a viewing distance and an interpupillary distance;

FIG. 4 shows a change in interpupillary distance that occurs in a situation where a gaze position switches between a far position and a near position;

FIG. 5 is a diagram for describing notification processing of a notification controller;

FIG. 6 is a flowchart for gaze change determination processing;

FIG. 7 shows a change pattern 1 for the interpupillary distance;

FIG. 8 shows a change pattern 2 for the interpupillary distance;

FIG. 9 shows an information image displayed by the notification processing of the notification controller;

FIG. 10 is a diagram for describing the notification processing of the notification controller;

FIG. 11 shows a configuration of a manipulation assistance system according to a second embodiment; and

FIG. 12 is a flowchart for describing a notification processing of a notification controller.

### DETAILED DESCRIPTION OF THE INVENTION

### 1. First embodiment

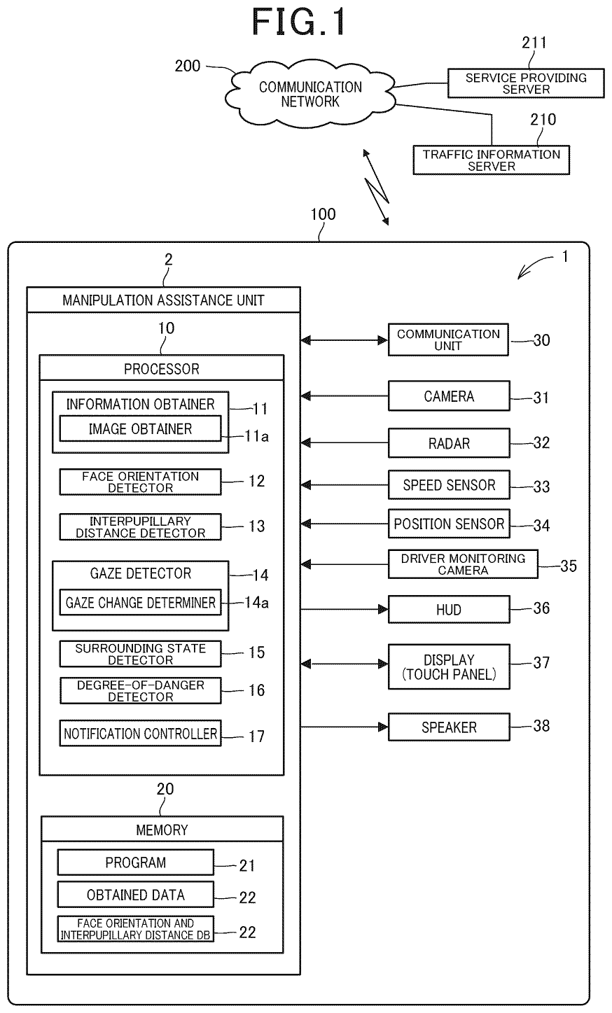

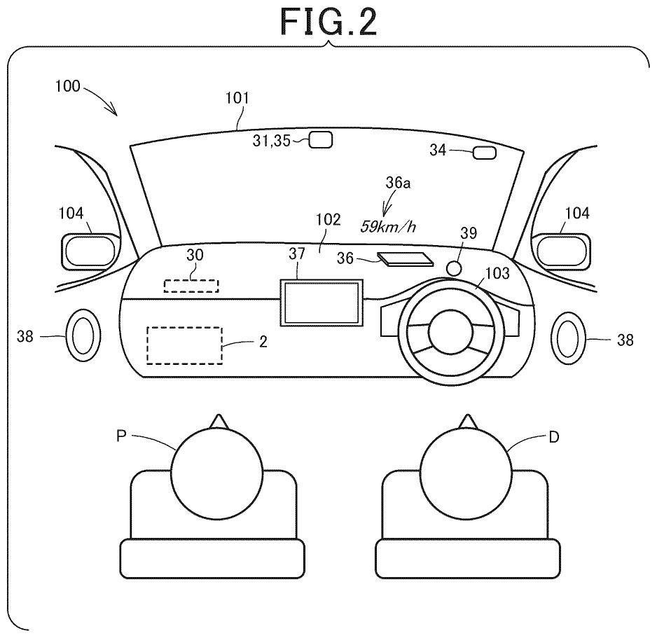

### 1.1 Configuration of Manipulation Assistance System With reference to FIGS. 1 and 2, a configuration of a manipulation assistance system 1 according to a first embodiment is described.

As shown in FIG. 1, the manipulation assistance system 1 includes a manipulation assistance unit 2 that includes a processor 10 and a memory 20. The manipulation assistance unit 2 is disposed in a vehicle 100 and may be called an in-vehicle unit. The manipulation assistance unit 2 is an example of a gaze detection apparatus of the present disclosure.

The manipulation assistance unit 2 is connected to a communication unit 30 (transmitter/receiver, circuit), a camera 31, a radar 32, a speed sensor 33, a position sensor 34, a driver monitoring camera 35, a HUD (Head-Up Display) 36, a display 37, and a speaker 38, which are disposed in or on the vehicle 100.

The vehicle 100 is a four-wheeled vehicle and an example of a vehicle of the present disclosure.

The communication unit 30 communicates with an external communication system, such as a traffic information server 210 (computer) and a service providing server 211 (computer), via a communication network 200.

The camera 31 captures an image of a surrounding area outside of the vehicle 100, the surrounding area including an area forward of the vehicle 100, and outputs a captured surrounding image to the manipulation assistance unit 2. The radar 32 detects a position of a target object (such as a preceding vehicle and an oncoming vehicle) located in the surrounding area which surrounds a vehicle body of the vehicle 100, the surrounding area including the area forward of the vehicle 100, and outputs position detection data to the manipulation assistance unit 2. The speed sensor 33 detects a traveling speed of the vehicle 100, and outputs speed detection data to the manipulation assistance unit 2. The position sensor 34 detects a current position of the vehicle 100 by using a publicly known positioning technology that uses GNSS or the like, and outputs current position data to the manipulation assistance unit 2.

As shown in FIG. 2, the driver monitoring camera 35 is disposed at an upper portion or the like of a windshield 101 of the vehicle 100, captures an image of a driver D of the vehicle 100, and outputs a face image of the driver D to the manipulation assistance unit 2. The driver D may be called user and occupant and is an example of a target person of the present disclosure. The HUD 36 projects an information image 36a on the windshield 101 for the driver D. The information image 36a is an image recognized by the driver U and superimposed on a visual recognition target (a road, a preceding vehicle, an oncoming vehicle, scenery, and the like) located in the area forward of the vehicle 100 and far from the vehicle 100.

In FIG. 2, the traveling speed of the vehicle 100 is shown as an example of the information image 36a, but this is not a limitation. The information image 36a can show various types of notification information. The notification information includes notification information related to driving manipulation, warning information, and notification information unrelated to driving manipulation.

The notification information related to driving manipulation includes, in addition to the traveling speed, traffic information obtained from the traffic information server 210, route guidance information obtained from a navigation system included in the vehicle 100, and the like.

The warning information includes a warning displayed about a target object near the vehicle, an error message and the like that notifies an abnormality of the vehicle 100, and the like.

The notification information unrelated to driving manipulation includes information about setting of climate control and the like for improving comfort in the vehicle, a manipulation state of an audio system of the vehicle 100, and the like.

The information image 36a is an example of an information display portion of the present disclosure.

The display 37 is disposed at a dashboard 102 of the vehicle 100 and displays various types of information in a manner visually recognizable by the driver D and a passenger P. The display 37 is a touch panel that, in response to the driver D touching to manipulate the display 37, outputs various instructions to the manipulation assistance unit 2. That is, the display 37 also serves as a manipulator. For example, the display 37 can display control screens for controlling the climate control, the audio system (for example, a radio or a volume), and the like of the vehicle 100, and setting screens for setting the climate control, the audio system, and the like.

The speaker 38 outputs various types of sound in the vehicle 100 under the control of the manipulation assistance unit 2. The speaker 38 outputs, for example, sound that is related to driving manipulation and sound from the audio system (for example, the radio), which the driver D and the passenger P can hear.

FIG. 2 also shows a steering wheel 103 disposed in front of the driver D and side view mirrors 104 disposed forward of the driver D and to the left and right of the driver D. The dashboard 102 may include instrumentation for displaying a state of the vehicle 100.

The processor 10 of the manipulation assistance unit 2 functions as a computer that controls the manipulation assistance unit 2. As shown in FIG. 1, the processor 10 functions as an information obtainer 11, a face orientation detector 12, an interpupillary distance detector 13, a gaze detector 14, a surrounding state detector 15, a degree-of-danger detector 16, a notification controller 17, and the like by reading and executing a program 21 recorded in the memory 20.

The information obtainer 11 includes an image obtainer 11a. The image obtainer 11a continuously obtains a face image of the driver D captured by the driver monitoring camera 35. The image obtained by the image obtainer 11a may be an image including the eyes and face of the driver D.

The information obtainer 11 can also obtain information obtained by the communication unit 30, the camera 31, the radar 32, the speed sensor 33, and the position sensor 34. FIG. 1 shows a case in which data thus obtained is recorded as obtained data 22 in the memory 20.

The face orientation detector 12 continuously detects orientation of the face (hereinafter called “face orientation”) of the driver D in the face image of the driver D obtained by the image obtainer 11a. Although processing for detecting the face orientation is not particularly limited, use of, for example, a publicly known image recognition algorithm allows accurate detection of the face orientation. Face orientation information detected by the face orientation detector 12 is recorded in the memory 20 in chronological order.

The interpupillary distance detector 13 continuously detects a distance between the left and right pupils (hereinafter called “interpupillary distance”) of the driver D in the image of the driver D obtained by the image obtainer 11a. To detect the interpupillary distance, image recognition processing is applied that involves detecting the left and right eyes in the image of the driver D, then, detecting a pupil portion (called “the colored part of the eye”) in each of the left and right eyes based on brightness of the detected left and right eyes, and detecting, as the interpupillary distance, a distance between the center positions of the pupil portions of the left and right eyes.

This image recognition processing uses an existing image recognition technology and thereby can facilitate detecting the interpupillary distance. Note that the processing to detect the interpupillary distance is not limited to the image recognition processing described above. For example, an image recognition processing may be applied that involves detecting an area including both the pupil portion and an iris portion for the left and right eyes, and detecting a distance between the center positions of the detected areas as the interpupillary distance. A colored portion of an eye of the present disclosure may either be the pupil portion or include both the pupil portion and the iris portion.

Interpupillary distances detected by the interpupillary distance detector 13 are recorded in the memory 20 in the chronological order. FIG. 1 shows a case in which face orientation data and interpupillary distance data are recorded as face orientation and interpupillary distance database (“DB” hereinafter) 22 in the memory 20. The face orientation and the interpupillary distance are recorded in such a manner in which the timing at which they are obtained can be identified.

The gaze detector 14 performs processing to detect a gaze position of the driver D based on the face orientation of the driver D detected by the face orientation detector 12 and the interpupillary distance of the driver D detected by the interpupillary distance detector 13. The gaze position may be referred to as a location in which a gaze is directed or as a visual recognition position.

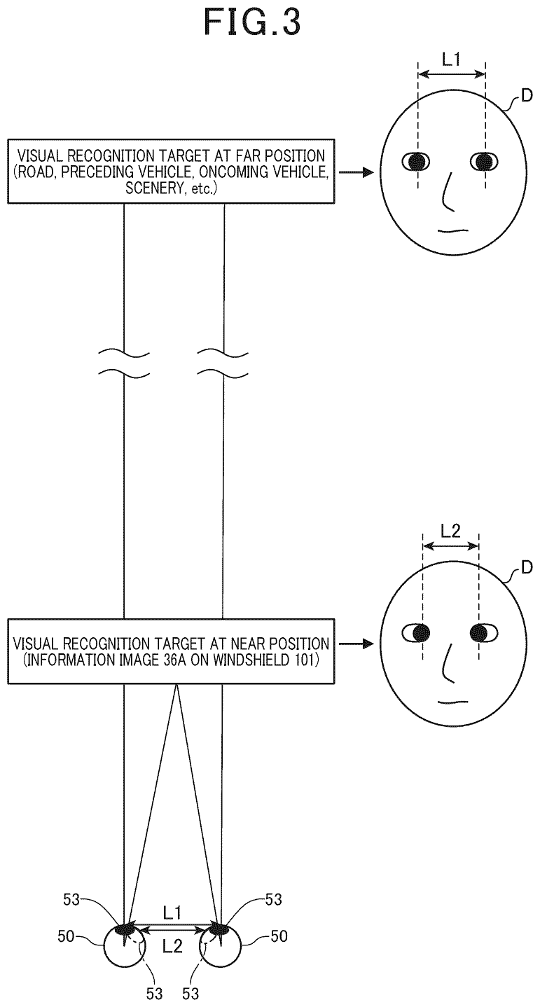

FIG. 3 shows a relationship between a viewing distance and the interpupillary distance. The viewing distance is a distance at which the left and right eyes visually recognize a visual recognition target, and it can be also called a focal length or a distance to the fixation point. In FIG. 3, reference sign 50 indicates left and right eyeballs of the driver D, and reference sign 53 indicates left and right irises (that are each called “the colored part of the eye” and each being a portion including a pupil).

As shown in FIG. 3, when the driver D is visually recognizing a visual recognition target located far from the driver D (a road, a preceding vehicle, an oncoming vehicle, scenery, and the like in the present embodiment) through the windshield 101, the gaze position is far and thus the viewing distance is long, giving a value L1 for the interpupillary distance of the driver D.

In contrast, as shown in FIG. 3, when the driver D is visually recognizing a visual recognition target located near to the driver D at the windshield 101 or in the vicinity of the windshield 101 (the information image 36a in the present embodiment), the gaze position is near and thus the viewing distance is short, giving a value L2 (which is shorter than the value L1) for the interpupillary distance of the driver D. When the distance to the gaze target changes in such a manner, an inward movement or outward movement of the pupils of the both eyes occur. These movements are called convergence/divergence movements.

As shown in FIG. 3, situations arise in which the driver D of the vehicle 100 is visually recognizing a visual recognition target located far from the driver D through the windshield 101, and the driver D is visually recognizing a visual recognition target located near to the driver D (the information image 36a); thus, the visual recognition position switches between a far position and a near position while the driver D is driving the vehicle.

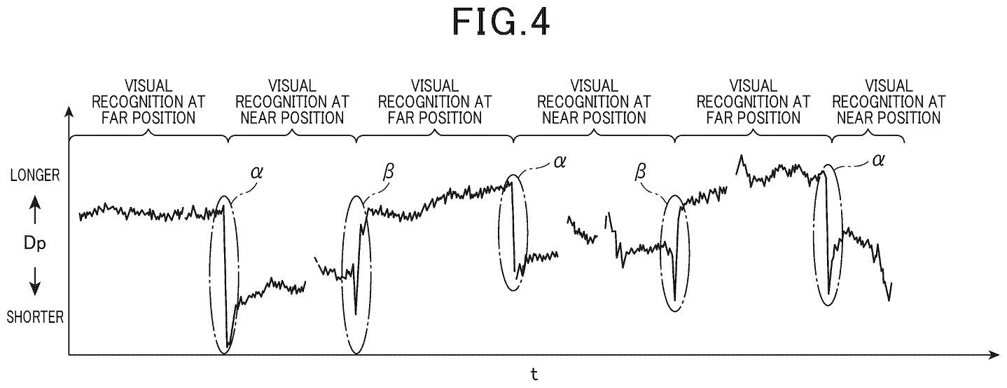

FIG. 4 shows changes in the interpupillary distance that occur when the gaze position of the driver D switches between the far position and the near position. In FIG. 4, a horizontal axis t represents elapsed time, and a vertical axis Dp represents the interpupillary distance (hereinafter referred to as “interpupillary distance Dp”). In FIG. 4, “visual recognition at far position” denotes a situation in which the driver D is visually recognizing a visual recognition target located far from the driver D through the windshield 101. In FIG. 4, “visual recognition at near position” denotes a situation in which the driver D is visually recognizing a visual recognition target located near to the driver D (the information image 36a).

In the description herein, a visual recognition target located far from the driver D is a visual recognition target located about, for example, a few meters to 100 meters ahead of the driver D; a visual recognition target located near to the driver D is a visual recognition target located about, for example, approximately 60 centimeters to one meter ahead of the driver D. The range of the far position and the range of near position may be ranges in which a particular eye movement described below occurs, and these ranges are not limited to the distances given above.

The inventors have directed their attention to the changes in the interpupillary distance Dp that occur when the gaze position of the driver D switches between the far position and the near position. In doing so, the inventors have discovered that, as shown in FIG. 4, at a timing of the switching of the gaze position, the particular eye movement occurs involving multiple occurrences of a sharp change in the interpupillary distance Dp.

More specifically, the inventors have discovered that, as shown in areas α in FIG. 4, when the gaze position changes from the far position to the near position, an eye movement occurs that involves a sharp decrease and then a sharp increase in the interpupillary distance Dp. Additionally, as shown in areas β in FIG. 4, the eye movement occurs that involves a sharp decrease and then a sharp increase in the interpupillary distance Dp, also when the gaze position changes from the near position to the far position. It can be inferred that this eye movement represents a particular reaction of the eyes in at least humans.

By detecting this particular eye movement, a change in the gaze position of the driver D between the far position and the near position can be identified. Moreover, this movement can be defined as multiple occurrences (two or more times) of change in the interpupillary distance Dp within a predefined time period, the change being equal to or greater than a predefined amount, and so, detecting this movement does not require a large amount of computations; thus, whether the movement has occurred can be detected rapidly without using a processor having high computational performance.

In the manipulation assistance system 1 according to the present embodiment, the gaze detector 14 includes a gaze change determiner 14a that, by detecting whether the particular eye movement described above has occurred, determines whether a change has occurred in the gaze position of the driver D, the change in the gaze position involving a change in the viewing distance. Specific processing and the like performed by the gaze change determiner 14a is described hereinafter.

The surrounding state detector 15 searches for a target object located in the area forward of the vehicle 100 based on an image of the area forward of the vehicle 100 captured by the camera 31 as well as the position detection data detected by the radar 32 for a target object in the area forward of the vehicle 100.

If the surrounding state detector 15 extracts a target object, the degree-of-danger detector 16 calculates a TTC (time to collision), which is a predicted time until the vehicle 100 comes in contact with the target object. The degree-of-danger detector 16 recognizes a target object having a calculated TTC equal to or less than a predefined time period as a target object that poses a degree of danger equal to or greater than a predefined degree of danger, and thus recognizes the target object as a warning target.

The degree of danger is not limited to those detected based on the TTC and may be detected based on information other than the TTC. The degree-of-danger detector 16 is an example of “a degree-of-danger detector configured to detect a degree of danger based on a relation between the vehicle and a state surrounding the vehicle” according to the present disclosure.

The notification controller 17 performs notification processing for the driver D based on at least any of a result of determining by the gaze change determiner 14a and a result of detecting by the degree-of-danger detector 16. The notification processing includes: processing to display the notification information related to driving manipulation by using the HUD 36 or the like; processing to display the warning information; and processing to output sound corresponding to the notification information and the warning information by using the speaker 38.

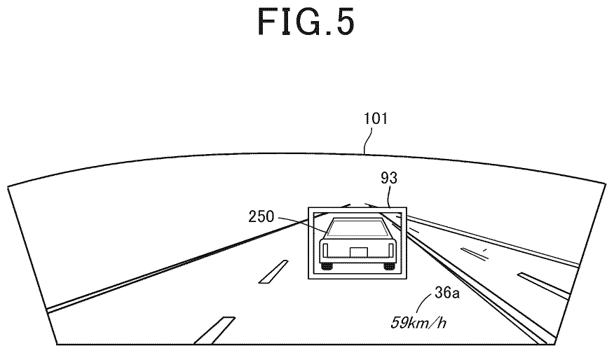

FIG. 5 shows an example of the notification processing of the notification controller 17. As shown in FIG. 5, in the notification processing for the driver D, the notification controller 17 causes the HUD 36 to project an outer frame 93 in a direction from the driver D toward a warning target 250 (a preceding vehicle in this example). The outer frame 93 can direct the attention of the driver D to the warning target 250. Additionally, the notification controller 17 may output sound that calls for attention (such as “Beware of the vehicle ahead.”) from the speaker 38.

### 1.2 Gaze Change Determination Processing

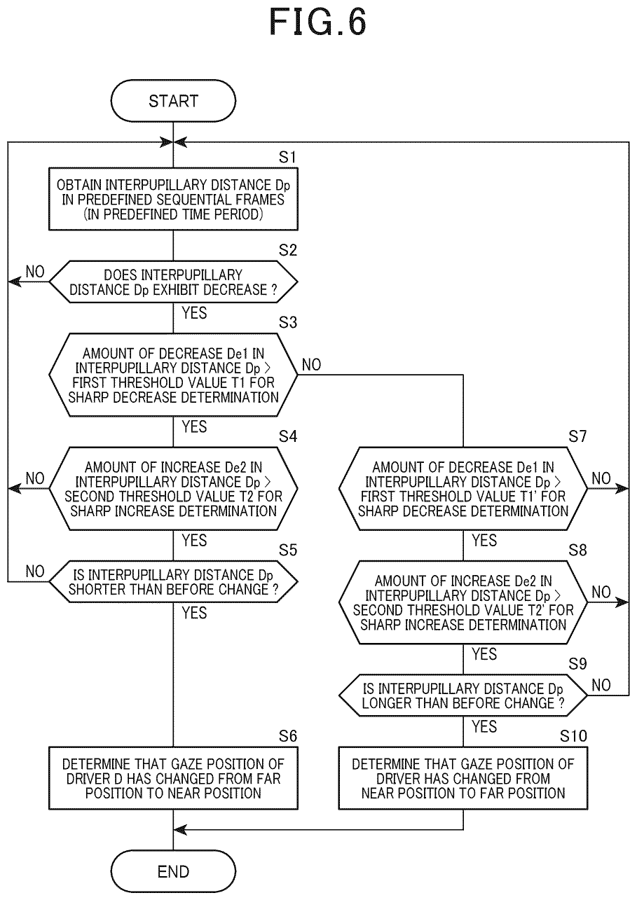

With reference to a flowchart shown in FIG. 6, gaze change determination processing performed by the gaze change determiner 14a is described. The gaze change determiner 14a continuously performs the processing shown in the flowchart in FIG. 6 when the vehicle 100 is in an operational state (with power supply ON).

The gaze change determiner 14a obtains interpupillary distances Dp (step S1), the interpupillary distances Dp having been detected in a predefined number of sequential frames (a predefined time period) by the interpupillary distance detector 13.

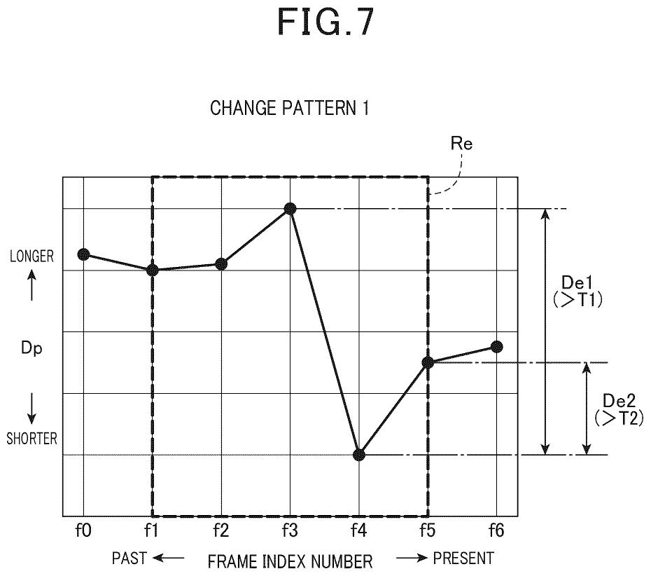

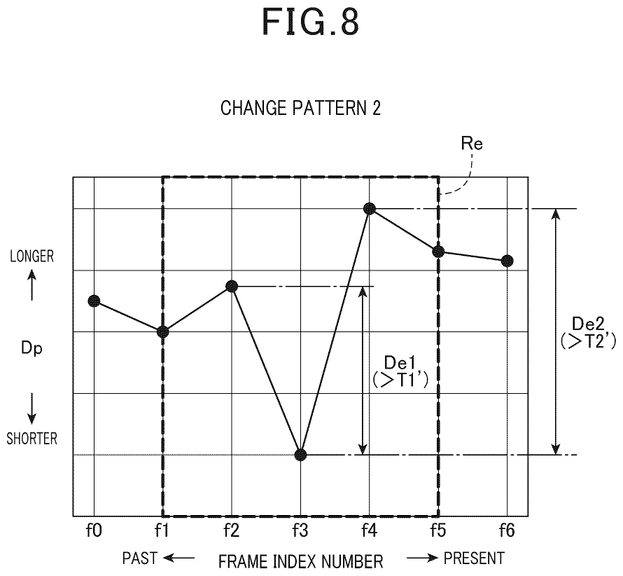

FIGS. 7 and 8 respectively show change pattern examples, in which, when the gaze position of the driver D changes between the far position and the near position, the eye movement occurs that involves a sharp decrease and then a sharp increase in the interpupillary distance Dp. FIG. 7 shows a change pattern example (a change pattern 1) in which the gaze position changes from the far position to the near position. FIG. 8 shows a change pattern example (a change pattern 2) in which the gaze position changes from the near position to the far position. In the examples described herein, interpupillary distances Dp from five frames from frames f1 to f5 shown in FIGS. 7 and 8 are obtained at step S1.

Subsequently, the gaze change determiner 14a determines whether the interpupillary distance Dp exhibits a decrease (step S2). If the interpupillary distance Dp exhibits a decrease, the gaze change determiner 14a proceeds to processing at step S3. Otherwise, the gaze change determiner 14a returns to the processing at step S1. When returning to step S1, the gaze change determiner 14a obtains interpupillary distances Dp from the predefined number of sequential frames and re-performs the processing at step S2 and beyond, the sequential frames being frames associated with frame index numbers shifted by the predefined number.

At step S3, the gaze change determiner 14a determines whether an amount of decrease De1 in the interpupillary distance Dp (see FIGS. 7 and 8) exceeds a first threshold value T1, which is for sharp decrease determination.

The first threshold value T1 is a threshold value that allows determination of the sharp decrease in the interpupillary distance Dp that occurs in the areas α and β illustrated in FIG. 4. More specifically, the first threshold value T1 is set to be a threshold value that allows determination of a sharp decrease in the interpupillary distance Dp in the change pattern 1 shown in FIG. 7.

If the amount of decrease De1 exceeds the first threshold value T1 (step S3; YES), and if the interpupillary distance Dp exhibits an increase after the decrease, the gaze change determiner 14a proceeds to processing at step S4.

At step S4, the gaze change determiner 14a determines whether an amount of increase De2 in the interpupillary distance Dp (see FIG. 7) that occurs after the decrease exceeds a second threshold value T2, which is for sharp increase determination.

The second threshold value T2 is a threshold value that allows determination of the sharp increase in the interpupillary distance Dp that occurs after the sharp decrease in the areas α and β in FIG. 4. More specifically, the second threshold value T2 is set to be a threshold value that allows determination of a sharp increase in the interpupillary distance Dp that occurs after the sharp decrease in the change pattern 1 shown in FIG. 7.

If the amount of increase De2 exceeds the second threshold value T2, which is for the sharp increase determination, (step S4; YES), it can be determined that a situation has arisen that corresponds to the events shown in the areas α and β in FIG. 4, in which the interpupillary distance Dp exhibits a sharp decrease and then a sharp increase. Thus, it can be determined that a change has occurred in the gaze position of the driver D between the far position and the near position; in other words, it can be determined that a change has occurred in the gaze position of the driver D, the change in the gaze position involving a change in the viewing distance. In this case, processing at step S5 is performed.

If the amount of increase De2 does not exceed the second threshold value T2, which is for the sharp increase determination, (step S4; NO), the gaze change determiner 14a returns to the processing at step S1.

At step S5, the gaze change determiner 14a determines whether the interpupillary distance Dp has shortened as compared to that before the change (before the sharp decrease). If the interpupillary distance Dp has shortened as compared to that before the change (step S5; YES), it shows that the gaze position of the driver D has changed to the near position (corresponding to the change pattern 1); thus, the gaze change determiner 14a determines that the gaze position of the driver D has changed from the far position to the near position (step S6). If the interpupillary distance Dp has not shortened as compared to that before the change (step S5; NO), the gaze change determiner 14a returns to the processing at step S1.

If, at step S3, the amount of decrease De1 does not exceed the first threshold value T1 (step S3; NO), the gaze change determiner 14a determines (step S7) whether the amount of decrease De1 in the interpupillary distance Dp (see FIGS. 7 and 8) exceeds a first threshold value T1′, which is for sharp decrease determination.

The first threshold value T1′ is a threshold value that allows determination of the sharp decrease in the interpupillary distance Dp that occurs in the areas α and β illustrated in FIG. 4. More specifically, the first threshold value T1′ is set to be a threshold value that allows determination of a sharp decrease in the interpupillary distance Dp in the change pattern 2 shown in FIG. 8.

According to a study conducted by the inventors, the amount of decrease De1 in the interpupillary distance Dp in the change pattern 2 tends to be smaller than the amount of decrease De1 in the interpupillary distance Dp in the change pattern 1. Thus, the first threshold value T1′ is preferably set to a smaller value than the first threshold value T1.

If the amount of decrease De1 exceeds the first threshold value T1′ (step S7; YES), and if the interpupillary distance Dp exhibits an increase after the decrease, the gaze change determiner 14a proceeds to processing at step S8.

If the amount of decrease De1 does not exceed the first threshold value T1′ (step S7; NO), the gaze change determiner 14a returns to the processing at step S1.

At step S8, the gaze change determiner 14a determines whether an amount of increase De2 in the interpupillary distance Dp (see FIG. 8) that occurs after the decrease exceeds a second threshold value T2′, which for sharp increase determination.

The second threshold value T2′ is a threshold value that allows determination of the sharp increase in the interpupillary distance Dp that occurs after the sharp decrease in the areas α and β in FIG. 4. More specifically, the second threshold value T2′ is set to be a threshold value that allows determination of a sharp increase in the interpupillary distance Dp that occurs after the sharp decrease in the change pattern 2 shown in FIG. 8.

According to the study conducted by the inventors, the amount of increase De2 in the interpupillary distance Dp in the change pattern 2 tends to be greater than the amount of increase De2 in the interpupillary distance Dp in the change pattern 1. Thus, the second threshold value T2′ is preferably set to a greater value than the second threshold value T2.

If the amount of increase De2 exceeds the second threshold value T2′, which is for the sharp increase determination, (step S8; YES), it can be determined that a situation has arisen that corresponds to the events shown in the areas α and β in FIG. 4, in which the interpupillary distance Dp exhibits a sharp decrease and then a sharp increase. In this case, processing at step S9 is performed.

If the amount of increase De2 does not exceed the second threshold value T2′, which is for the sharp increase determination, (step S8; NO), the gaze change determiner 14a returns to the processing at step S1.

At step S9, the gaze change determiner 14a determines whether the interpupillary distance Dp has lengthened as compared to that before the change (before the sharp decrease). If the interpupillary distance Dp has lengthened as compared to that before the change (step S9; YES), it shows that the gaze position of the driver D has changed to the far position (corresponding to the change pattern 2); thus, the gaze change determiner 14a determines that the gaze position of the driver D has changed from the near position to the far position (step S10). If the interpupillary distance Dp has not lengthened as compared to that before the change (step S9; NO), the gaze change determiner 14a returns to the processing at step S1.

The gaze change determiner 14a may determine a more specific gaze position of the driver D by using a result of the determination based on the interpupillary distance Dp described above.

For example, if the gaze change determiner 14a determines that the gaze position of the driver D has changed from the far position to the near position, the gaze change determiner 14a may determine that the driver D is looking at the windshield 101 because it is likely that situations have changed from one in which the driver D is visually recognizing a visual recognition target located far from the driver D through the windshield 101 to another in which the driver D is visually recognizing the windshield 101 (for example, the information image 36a).

The gaze change determiner 14a may also determine a more specific gaze position of the driver D by using, in addition to a result of the determination based on the interpupillary distance Dp described above, a result of detection by the face orientation detector 12.

In one example, if the gaze change determiner 14a determines that the gaze position of the driver D has changed from the far position to the near position, and if the face of the driver D is oriented toward either the left or right according to the face orientation detector 12, it is determined that the driver D is looking at one of the side view mirrors 104. In another example, if the gaze change determiner 14a determines that the gaze position of the driver D has changed from the far position to the near position, and if the face of the driver D is oriented toward a center in a vehicle width direction according to the face orientation detector 12, it is determined that the driver D is looking at the display 37, which is located at the center in the vehicle width direction and serving as a center display portion. In this manner, a more specific gaze position of the driver D can be identified.

### 1.3 Notification Processing

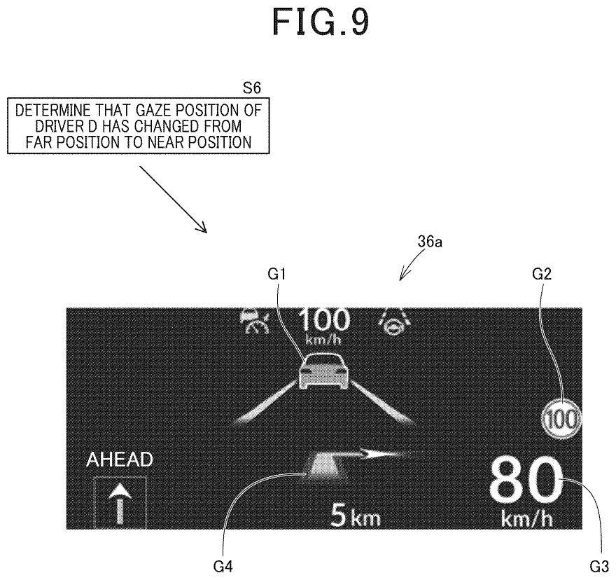

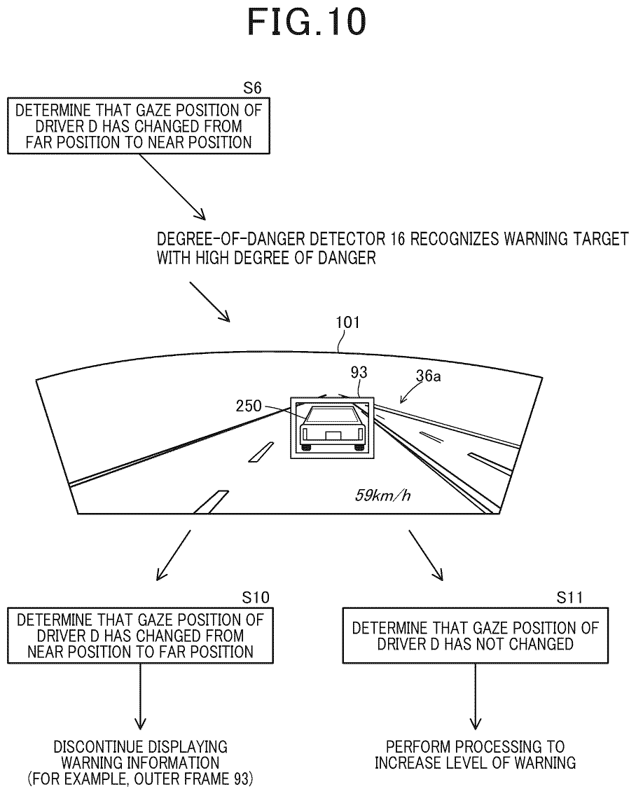

With reference to FIGS. 9 and 10, the notification processing performed by the notification controller 17 is described. As shown in FIG. 9, if the gaze change determiner 14a determines that the gaze position of the driver D has changed from the far position to the near position (step S6), the notification controller 17 performs processing to project the information image 36a shown in FIG. 9 on the windshield 101, the information image 36a being provided as the notification information related to driving manipulation.

In the information image 36a in FIG. 9, an image G1 indicates a target object located forward of the vehicle 100 and extracted by the surrounding state detector 15, and an image G2 indicates a sign recognized by the surrounding state detector 15 in an image from the camera 31. An image G3 indicates the traveling speed of the vehicle 100, and an image G4 indicates route guidance information obtained from the navigation system included in the vehicle 100.

For example, some of the images G1 to G4 (for example, the image G3 indicating the traveling speed) may be displayed normally, while the other images may be displayed if the gaze change determiner 14a determines that the gaze position of the driver D has changed from the far position to the near position (which includes a case in which the gaze change determiner 14a determines that the driver D is looking at the windshield 101 (at the information image 36a, for example)). The content of the information image 36a, in other words, the notification information related to driving manipulation, may be changed as appropriate.

As shown in FIG. 10, if the gaze change determiner 14a determines that the gaze position of the driver D has changed from the far position to the near position, and if the degree-of-danger detector 16 recognizes the warning target 250 posing a degree of danger equal to or greater than the predefined degree of danger, the warning information (the outer frame 93 shown in FIG. 10), which is different from the notification information related to driving manipulation shown as an example in FIG. 9, may be displayed.

If the gaze change determiner 14a determines that the gaze position of the driver D has changed from the near position to the far position after the warning information (the outer frame 93) is displayed (step S10), displaying the warning information (the outer frame 93) may be discontinued. If the gaze change determiner 14a determines that the gaze position of the driver D has not changed after the warning information (the outer frame 93) is displayed (step S11), processing to increase the level of the warning may be performed. As the processing to increase the level of the warning, for example, a warning may be displayed in the information image 36a to increase the level of the warning, or warning sound or the like may be output from the speaker 38 to increase the level of the warning.

The gaze change determiner 14a may determine that the gaze position of the driver D has not changed if, for example, the interpupillary distance Dp has not changed. The warning information is not limited to the outer frame 93 and may be modified as appropriate.

As described above, the manipulation assistance unit 2 includes: the interpupillary distance detector 13 that detects the interpupillary distance Dp between the left and right eyes of the driver D, who is the target person, based on an image including the eyes of the driver D; and the gaze detector 14 that detects the gaze position of the driver D based on obtained information including the interpupillary distance Dp, wherein the gaze detector 14 includes a gaze change determiner 14a that determines that, if the gaze change determiner 14a detects an eye movement based on the obtained information, the eye movement involving two occurrences of change in the interpupillary distance Dp within a predefined time period, the change in the interpupillary distance Dp being equal to or greater than a predefined amount, a change has occurred in the gaze position of the driver D, the change in the gaze position involving a change in the viewing distance.

In this way, use of the particular eye movement in at least humans allows rapid identification of a change in the gaze position of the driver D. This enables real-time determination of the gaze position of the driver D and immediate response to change in attention of the driver D and change in driving situation, thus allowing contribution to improvement of safety. Contribution can also be made to further improvement of traffic safety and the advance of sustainable traffic systems.

While, in the present embodiment, the gaze detector 14 detects an eye movement that involves two occurrences of the change in the interpupillary distance Dp equal to or greater than the predefined amount within the predefined time period, the gaze detector 14 may detect an eye movement that involves two or more occurrences of the change. In this case also, use of the particular eye movement allows rapid identification of a change in gaze position of the driver D.

In the present embodiment, the processing of the interpupillary distance detector 13 represents an example of an interpupillary distance detection step according to the present disclosure. The processing of the gaze detector 14 represents an example of a gaze detection step according to the present disclosure. The processing of the gaze change determiner 14a represents an example of a gaze change determination step according to the present disclosure. The processing of the surrounding state detector 15 represents an example of a surrounding state detection step according to the present disclosure. The processing of the degree-of-danger detector 16 represents an example of a degree-of-danger detection step according to the present disclosure. The processing of the notification controller 17 represents an example of a notification step according to the present disclosure.

### 2. Second Embodiment

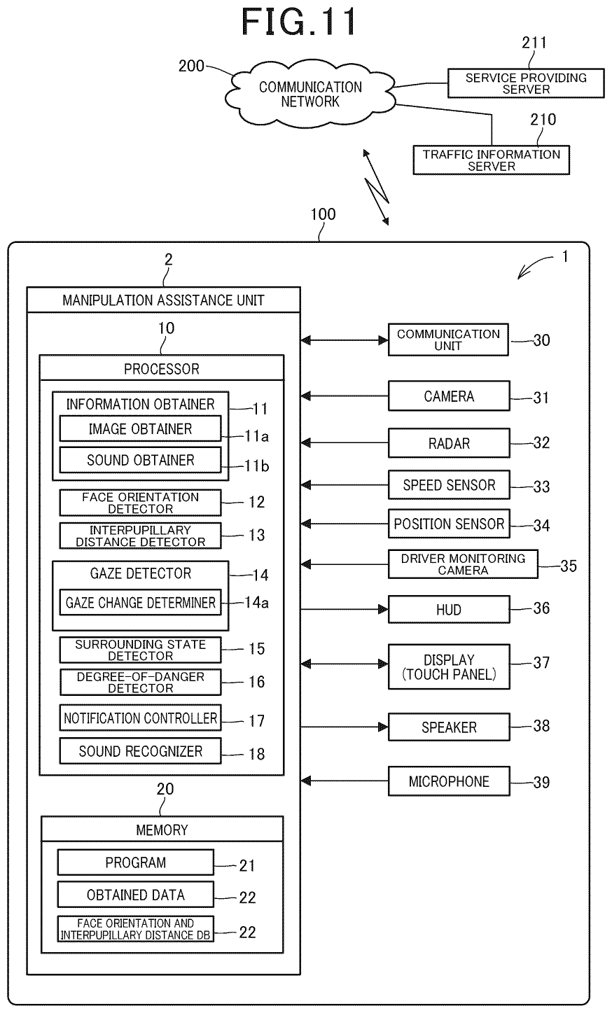

With reference to FIG. 11, a configuration of a manipulation assistance system 1 according to a second embodiment is described.

The second embodiment is different from the first embodiment in that the manipulation assistance system 1 includes a microphone 39, a sound obtainer 11b, and a sound recognizer 18, and that, by using these constituent elements, a notification controller 17 performs notification processing that is related to a task to be performed by a driver D or the like. Other constituent elements and the like are similar to those of the first embodiment, so the differences from the first embodiment are described below. In FIG. 11, constituent elements similar to those of the first embodiment are assigned the same reference signs.

The microphone 39 is connected to a manipulation assistance unit 2 and collects sound within the vehicle 100 and outputs the collected sound to the manipulation assistance unit 2. The microphone 39 is disposed in the vicinity of the driver D and can collect a sound from the driver D and a passenger P.

The sound obtainer 11b is part of the configuration of the information obtainer 11 and obtains sound collected through the microphone 39.

The sound recognizer 18 recognizes sound obtained by the sound obtainer 11b and generates text data derived from sound data based on a result of the recognition. Additionally, the sound recognizer 18 has a function of detecting a predefined task or command based on the obtained text data. More specifically, the sound recognizer 18 can reference a sound command or keyword for enabling identification of a task to be performed by the driver D and identify a corresponding task from the obtained text data.

Such tasks include manipulation performed by the driver D via the display 37; for example, manipulation to turn ON/OFF the climate control, manipulation to adjust the climate control, and manipulation on the audio system (the radio, the volume, or the like).

Thus, if a conversation between the driver D and the passenger P includes a sound that is related to the display 37, such as, for example, “turn on the air conditioner” or “turn on the radio”, the sound recognizer 18 can detect a task to be performed via the display 37 in advance based on the conversation.

### 2.1 Notification Processing

In addition to the notification processing that uses the HUD 36 and the speaker 38 described in the first embodiment, the notification controller 17 uses the display 37 to perform other notification processing that contributes to improvement of convenience for the driver D.

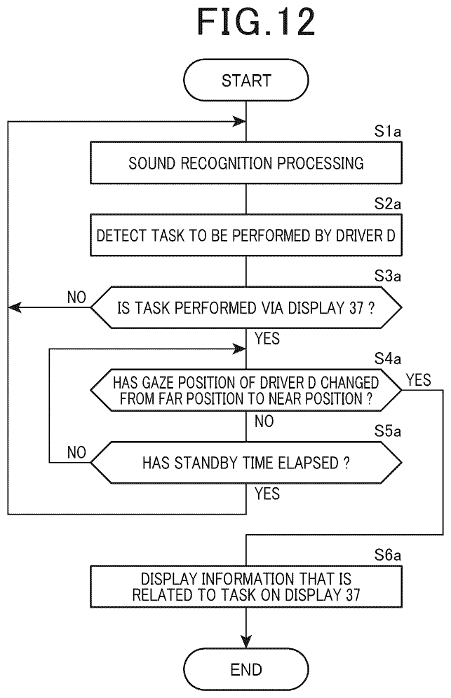

With reference to a flowchart shown in FIG. 12, the notification processing performed by the notification controller 17 and related processing are described. The processing shown in the flowchart in FIG. 12 is continuously performed either when the vehicle 100 is in the operational state (with the power supply ON), or when the vehicle 100 is in the operational state (with the power supply ON) and is traveling.

As shown in FIG. 12, the sound recognizer 18 performs sound recognition processing to recognize a sound from the driver D and the like in the vehicle (step S1a). Based on a result of the recognition, the sound recognizer 18 detects (step S2a) a task to be performed by the driver D.

Subsequently, the notification controller 17 determines (step S3a) whether the task detected by the sound recognizer 18 is a task to be performed through (a touch to manipulate) the display 37. If the detected task is not a task to be performed through (a touch to manipulate) the display 37 (step S3a: YES), the notification controller 17 performs processing at step S4a. Otherwise (step S3a: NO), the operation returns to the processing at step S1a.

At step S4a, the notification controller 17 determines whether the gaze change determiner 14a has determined that the gaze position of the driver D has changed from the far position to the near position. If the gaze change determiner 14a has not determined that the gaze position of the driver D has changed from the far position to the near position (step S4a: NO) at this point of time, the notification controller 17 repeats the determination processing at step S4a until a predefined standby time elapses (step S5a: YES).

This means that the notification controller 17 is put on standby until the gaze position of the driver D is shifted to the near position, because, in order for the driver D to perform the task detected at step S2a, the driver D needs to shift the gaze position to the near position (at the position of the display 37).

If the gaze change determiner 14a has determined that the gaze position of the driver D has changed from the far position to the near position (step S4a: YES), the notification controller 17 displays information that is related to the task on the display 37 (step S6a).

For example, if the task is related to manipulation of the climate control, the notification controller 17 performs processing to display a manipulation screen for manipulating the climate control on the display 37 or processing to highlight a manipulation button for manipulating the climate control, as information that is related to the task. If the task is related to manipulation of the radio, the volume, or the like, the notification controller 17 performs processing to display a manipulation screen for the radio, the volume, or the like on the display 37 or processing to highlight a manipulation button for the radio, the volume, or the like, as information that is related to the task. The convenience for the driver D is thereby improved.

### 3. Other Embodiments

The foregoing embodiments merely describe some aspects of the present invention and may be modified and applied in any way without departing from the spirit of the present invention.

For example, while the foregoing embodiments describe examples in which, if the gaze change determiner 14a determines that the gaze position of the driver D has changed from the far position to the near position, it is determined that the driver D is looking at the windshield 101 (the information image 36a, for example), it may be determined that the driver D is looking at the dashboard 102. For example, if the information image 36a is not projected on the windshield 101, it is likely that the driver D is looking at the instrumentation or the display 37 (the center display portion), which are disposed at the dashboard 102.

If the HUD 36 is not provided, the notification information (including the notification information related to driving manipulation, the warning information, and the notification information unrelated to driving manipulation) displayed in the information image 36a may be displayed in the information display portion disposed at the dashboard 102, such as at the display 37, the instrumentation, or the like.

While examples have been described in which the present invention is applied to the manipulation assistance unit 2 that is disposed in the vehicle 100 and serves as the gaze detection apparatus, the present invention may be applied to the gaze detection apparatus disposed in any mobile body for which the driver D performs driving manipulation. The mobile body may be an aircraft, a motorcycle, a watercraft, or the like.

The configuration of the constituent elements shown in each of FIGS. 1, 11 and the like may be any configuration implemented by software, any configuration implemented by hardware, or any configuration implemented by a combination of software and hardware. Additionally, the configuration of the gaze detection apparatus according to the present invention may be implemented in part or in full in a system external to the vehicle 100, such as a server on the communication network 200. In this case, information obtained at the vehicle 100 is transmitted to the external system, at least part of the processing performed by the gaze detection apparatus is performed at the external system, and output data based on a result of the processing is transmitted to the vehicle 100, so that various notifications and warnings may be provided in the vehicle 100.

Furthermore, how to divide the processing and sequential order of the processing shown in the flowcharts are not limitations and may be changed as appropriate.

Additionally, while an example has been described in which the program 21 for executing a gaze detection method according to the present invention is recorded in the gaze detection apparatus, the program 21 may be obtained from an external device through communication. The program 21 may be recorded in a recording medium in a computer readable manner. The recording medium may be a magnetic recording medium, an optical recording medium, a semiconductor memory device, or the like.

### 4. Configurations Supported by Foregoing Embodiments

The embodiments described above are specific examples of the following configurations.

(First configuration) A gaze detection apparatus including: an interpupillary distance detector configured to detect an interpupillary distance between left and right eyes of a target person based on an image including the eyes of the target person; and a gaze detector configured to detect a gaze position of the target person based on obtained information including the interpupillary distance, wherein the gaze detector includes a gaze change determiner configured to determine that, if the gaze change determiner detects an eye movement based on the obtained information, the eye movement involving a plurality of occurrences of change in the interpupillary distance within a predefined time period, the change in the interpupillary distance being equal to or greater than a predefined amount, a change has occurred in the gaze position of the target person, the change in the gaze position involving a change in viewing distance.

In accordance with this configuration, use of the particular eye movement in at least humans allows rapid identification of a change in the gaze position of the target person, thereby allowing contribution to the improvement of safety.

(Second configuration) The gaze detection apparatus according to the first configuration, wherein the gaze change determiner determines that the gaze position of the target person has changed from a far position to a near position, if the gaze change determiner detects that an amount of change in the interpupillary distance exhibits a decrease equal to or greater than a predefined threshold value and then the amount of change in the interpupillary distance exhibits an increase equal to or greater than a predefined threshold value, and if the gaze change determiner detects that the interpupillary distance has shortened as compared to the interpupillary distance before a change.

In accordance with this configuration, a change in the gaze position of the target person from the far position to the near position can be identified rapidly.

(Third configuration) The gaze detection apparatus according to the first configuration or the second configuration, wherein the gaze change determiner determines that the gaze position of the target person has changed from a near position to a far position, if the gaze change determiner detects that an amount of change in the interpupillary distance exhibits a decrease equal to or greater than a predefined threshold value and then the amount of change in the interpupillary distance exhibits an increase equal to or greater than a predefined threshold value, and if the gaze change determiner detects that the interpupillary distance has lengthened as compared to the interpupillary distance before a change.

In accordance with this configuration, a change in the gaze position of the target person from the near position to the far position can be identified rapidly.

(Fourth configuration) The gaze detection apparatus according to any one of the first configuration to the third configuration, wherein the gaze detection apparatus is disposed in a vehicle, and the target person is an occupant of the vehicle.

In accordance with this configuration, a change in the gaze position of an occupant of the vehicle can be identified rapidly.

(Fifth configuration) The gaze detection apparatus according to the third configuration, wherein the gaze detection apparatus is disposed in a vehicle, the target person is a driver of the vehicle, and if the gaze change determiner determines that the gaze position of the driver has changed from the far position to the near position, the gaze change determiner determines that the driver is viewing at least any of a windshield or a dashboard of the vehicle.

In accordance with this configuration, a change in the gaze position of the driver to the windshield or to the dashboard can be identified rapidly.

(Sixth configuration) The gaze detection apparatus according to the second configuration, wherein the gaze detection apparatus is disposed in a vehicle, the target person is a driver of the vehicle, and if the gaze change determiner determines that the gaze position of the driver of the vehicle has changed from the far position to the near position, and if a change in face orientation of the driver has been detected, the gaze change determiner determines that the driver is looking at a center display portion disposed at a center in a vehicle width direction of the vehicle or at a side view mirror.

In accordance with this configuration, a change in the gaze position of the driver to the center display portion or to one of the side view mirrors can be identified rapidly. Whether the driver is looking at the center display portion or one of the side view mirrors can be identified from the orientation of the face.

(Seventh configuration) The gaze detection apparatus according to the fifth configuration, further including: a notification controller configured to display notification information related to driving manipulation in an information display portion disposed at the windshield or the dashboard, if the gaze change determiner determines that the gaze position has changed from the far position to the near position.

In accordance with this configuration, displaying the notification information related to driving manipulation at a location in agreement with the gaze position of the driver enables the driver to check necessary information at an appropriate timing.

(Eighth configuration) The gaze detection apparatus according to the seventh configuration, further including: a surrounding state detector configured to detect a state surrounding the vehicle; and a degree-of-danger detector configured to detect a degree of danger based on a relation between the vehicle and the state surrounding the vehicle, wherein, if the gaze change determiner determines that the gaze position has changed from the far position to the near position, and if the degree of danger is equal to or greater than a predefined degree of danger, warning information that is different from the notification information related to driving manipulation is displayed in the information display portion.

In accordance with this configuration, if a situation posing a high degree of danger arises outside of the vehicle when the driver is looking at the near position, the warning information can be provided for the driver swiftly, facilitating avoidance of the danger.

(Ninth configuration) The gaze detection apparatus according to the eighth configuration, wherein the gaze change determiner determines that the gaze position of the target person has changed from the near position to the far position, if the gaze change determiner detects that the amount of change in the interpupillary distance exhibits the decrease equal to or greater than the predefined threshold value and then the amount of change in the interpupillary distance exhibits the increase equal to or greater than the predefined threshold value, and if the gaze change determiner detects that the interpupillary distance has lengthened as compared to the interpupillary distance before the change, the notification controller performs processing to discontinue displaying the warning information if the gaze change determiner determines that the gaze position has changed from the near position to the far position after the warning information is displayed, and the notification controller performs processing to increase a level of warning provided by the warning information if the gaze change determiner determines that the gaze position has not changed after the warning information is displayed.

In accordance with this configuration, appropriate processing, either to discontinue the warning or to increase the level of the warning, can be performed in agreement with the gaze position of the driver after the warning information is displayed; thus, avoidance of danger can be facilitated.

(Tenth configuration) The gaze detection apparatus according to any one of the seventh configuration to the ninth configuration, further including a sound recognizer configured to recognize sound in the vehicle, wherein the notification controller has a function of detecting a task to be performed by the driver based on a result of the recognizing of the sound, detects the task, and, if the gaze change determiner determines that the gaze position has changed from the far position to the near position, displays information that is related to the task in the information display portion.

In accordance with this configuration, when the driver performs a task, information that is related to the task can be displayed at an appropriate position and at an appropriate timing, thereby improving the convenience.

(Eleventh configuration) The gaze detection apparatus according to any one of the first configuration to the tenth configuration, wherein the interpupillary distance detector detects the left and right eyes in the image, detects colored portions of the left and right eyes based on brightness of the detected left and right eyes, and detects a distance between center positions of the detected left and right colored portions as the interpupillary distance.

In accordance with this configuration, the interpupillary distance can be detected easily by using an existing image recognition technology.

(Twelfth configuration) The gaze detection apparatus according to the third configuration, wherein the gaze change determiner determines whether the gaze position of the target person has changed from the near position to the far position by using the amount of change in the interpupillary distance exhibited when the gaze position has changed from the near position to the far position being smaller than the amount of change in the interpupillary distance exhibited when the gaze position has changed from the far position to the near position.

In accordance with this configuration, whether the gaze position of the target person has changed from the near position to the far position can be determined with accuracy by using the amount of change in the interpupillary distance exhibited when the gaze position of the target person has changed from the near position to the far position (change pattern 2) being smaller than the amount of change in the interpupillary distance exhibited when the gaze position has changed from the far position to the near position (change pattern 1). Accuracy in determining whether the gaze position is far or near is thus improved.

(Thirteenth configuration) A gaze detection method executed by a gaze detection apparatus, the method including: an interpupillary distance detection step of detecting an interpupillary distance between left and right eyes of a target person based on an image including the eyes of the target person; and a gaze detection step of detecting a gaze position of the target person based on obtained information including the interpupillary distance, wherein the gaze detection step includes gaze change determination processing to determine that, if an eye movement is detected based on the obtained information, the eye movement involving a plurality of occurrences of change in the interpupillary distance within a predefined time period, the change in the interpupillary distance being equal to or greater than a predefined amount, a change has occurred in the gaze position of the target person, the change in the gaze position involving a change in viewing distance.

In accordance with this method, the use of the particular eye movement in at least humans allows rapid identification of a change in the gaze position of the target person, thereby allowing contribution to the improvement of safety.

(Fourteenth configuration) A non-transitory computer readable recording medium recording a program that causes a computer-controlled gaze detection apparatus to function as: an interpupillary distance detector that detects an interpupillary distance between left and right eyes of a target person based on an image including the eyes of the target person; and a gaze detector that detects a gaze position of the target person based on obtained information including the interpupillary distance, wherein the gaze detector includes gaze change determination processing to determine that, if an eye movement is detected based on the obtained information, the eye movement involving a plurality of occurrences of change in the interpupillary distance within a predefined time period, the change in the interpupillary distance being equal to or greater than a predefined amount, a change has occurred in the gaze position of the target person, the change in the gaze position involving a change in viewing distance.

In accordance with this recording medium, use of the particular eye movement in at least humans allows rapid identification of a change in the gaze position of the target person, thereby allowing contribution to the improvement of safety.

### REFERENCE SIGNS LIST

1 manipulation assistance system
2 manipulation assistance unit (gaze detection apparatus)
10 processor
11 information obtainer
12 face orientation detector
13 interpupillary distance detector
14 gaze detector
14a gaze change determiner
15 surrounding state detector
16 degree-of-danger detector
17 notification controller
18 sound recognizer
20 memory
21 program
30 communication unit
31 camera
32 radar
33 speed sensor
34 position sensor
35 driver monitoring camera
36 HUD
36a information image (information display portion)
37 display (information display portion, center display portion)
38 speaker
39 microphone
100 vehicle
101 windshield
102 dashboard
104 side view mirror
D driver (target person)
P passenger
Dp interpupillary distance

1. A gaze detection apparatus comprising:
an interpupillary distance detector configured to detect an interpupillary distance between left and right eyes of a target person based on an image including the eyes of the target person; and
a gaze detector configured to detect a gaze position of the target person based on obtained information including the interpupillary distance, wherein
the gaze detector comprises a gaze change determiner configured to determine that, if the gaze change determiner detects an eye movement based on the obtained information, the eye movement involving a plurality of occurrences of change in the interpupillary distance within a predefined time period, the change in the interpupillary distance being equal to or greater than a predefined amount, a change has occurred in the gaze position of the target person, the change in the gaze position involving a change in viewing distance.

2. The gaze detection apparatus according to claim 1, wherein
the gaze change determiner determines that the gaze position of the target person has changed from a far position to a near position, if the gaze change determiner detects that an amount of change in the interpupillary distance exhibits a decrease equal to or greater than a predefined threshold value and then the amount of change in the interpupillary distance exhibits an increase equal to or greater than a predefined threshold value, and if the gaze change determiner detects that the interpupillary distance has shortened as compared to the interpupillary distance before a change.

3. The gaze detection apparatus according to claim 1, wherein
the gaze change determiner determines that the gaze position of the target person has changed from a near position to a far position, if the gaze change determiner detects that an amount of change in the interpupillary distance exhibits a decrease equal to or greater than a predefined threshold value and then the amount of change in the interpupillary distance exhibits an increase equal to or greater than a predefined threshold value, and if the gaze change determiner detects that the interpupillary distance has lengthened as compared to the interpupillary distance before a change.

4. The gaze detection apparatus according to claim 1, wherein
the gaze detection apparatus is disposed in a vehicle, and
the target person is an occupant of the vehicle.

5. The gaze detection apparatus according to claim 2, wherein
the gaze detection apparatus is disposed in a vehicle,
the target person is a driver of the vehicle, and
if the gaze change determiner determines that the gaze position of the driver has changed from the far position to the near position, the gaze change determiner determines that the driver is viewing at least any of a windshield or a dashboard of the vehicle.

6. The gaze detection apparatus according to claim 2, wherein
the gaze detection apparatus is disposed in a vehicle,
the target person is a driver of the vehicle, and
if the gaze change determiner determines that the gaze position of the driver of the vehicle has changed from the far position to the near position, and if a change in face orientation of the driver has been detected, the gaze change determiner determines that the driver is looking at a center display portion disposed at a center in a vehicle width direction of the vehicle or at a side view mirror.

7. The gaze detection apparatus according to claim 5, further comprising:
a notification controller configured to display notification information related to driving manipulation in an information display portion disposed at the windshield or the dashboard, if the gaze change determiner determines that the gaze position has changed from the far position to the near position.

8. The gaze detection apparatus according to claim 7, further comprising:
a surrounding state detector configured to detect a state surrounding the vehicle; and
a degree-of-danger detector configured to detect a degree of danger based on a relation between the vehicle and the state surrounding the vehicle, wherein
if the gaze change determiner determines that the gaze position has changed from the far position to the near position, and if the degree of danger is equal to or greater than a predefined degree of danger, warning information that is different from the notification information related to driving manipulation is displayed in the information display portion.

9. The gaze detection apparatus according to claim 8, wherein
the gaze change determiner determines that the gaze position of the target person has changed from the near position to the far position, if the gaze change determiner detects that the amount of change in the interpupillary distance exhibits the decrease equal to or greater than the predefined threshold value and then the amount of change in the interpupillary distance exhibits the increase equal to or greater than the predefined threshold value, and if the gaze change determiner detects that the interpupillary distance has lengthened as compared to the interpupillary distance before the change,
the notification controller performs processing to discontinue displaying the warning information if the gaze change determiner determines that the gaze position has changed from the near position to the far position after the warning information is displayed, and the notification controller performs processing to increase a level of warning provided by the warning information if the gaze change determiner determines that the gaze position has not changed after the warning information is displayed.

10. The gaze detection apparatus according to claim 7, further comprising
a sound recognizer configured to recognize sound in the vehicle, wherein
the notification controller has a function of detecting a task to be performed by the driver based on a result of the recognizing of the sound, detects the task, and, if the gaze change determiner determines that the gaze position has changed from the far position to the near position, displays information that is related to the task in the information display portion.

11. The gaze detection apparatus according to claim 1, wherein
the interpupillary distance detector detects the left and right eyes in the image, detects colored portions of the left and right eyes based on brightness of the detected left and right eyes, and detects a distance between center positions of the detected left and right colored portions as the interpupillary distance.

12. The gaze detection apparatus according to claim 3, wherein
the gaze change determiner determines whether the gaze position of the target person has changed from the near position to the far position by using the amount of change in the interpupillary distance exhibited when the gaze position has changed from the near position to the far position being smaller than the amount of change in the interpupillary distance exhibited when the gaze position has changed from the far position to the near position.

13. A gaze detection method executed by a gaze detection apparatus, the method comprising:
an interpupillary distance detection step of detecting an interpupillary distance between left and right eyes of a target person based on an image including the eyes of the target person; and
a gaze detection step of detecting a gaze position of the target person based on obtained information including the interpupillary distance, wherein
the gaze detection step comprises gaze change determination processing to determine that, if an eye movement is detected based on the obtained information, the eye movement involving a plurality of occurrences of change in the interpupillary distance within a predefined time period, the change in the interpupillary distance being equal to or greater than a predefined amount, a change has occurred in the gaze position of the target person, the change in the gaze position involving a change in viewing distance.

14. A non-transitory computer readable recording medium recording a program that causes a computer-controlled gaze detection apparatus to function as:
an interpupillary distance detector that detects an interpupillary distance between left and right eyes of a target person based on an image including the eyes of the target person; and
a gaze detector that detects a gaze position of the target person based on obtained information including the interpupillary distance, wherein
the gaze detector comprises gaze change determination processing to determine that, if an eye movement is detected based on the obtained information, the eye movement involving a plurality of occurrences of change in the interpupillary distance within a predefined time period, the change in the interpupillary distance being equal to or greater than a predefined amount, a change has occurred in the gaze position of the target person, the change in the gaze position involving a change in viewing distance.
